(19) United States
(12) Patent Application Publication
(10) Pub. No.: US 2021/0171185 A1
(43) Pub. Date: Jun. 10, 2021

(54) Space-efficiently Stowable, Automatably Deployable, Condensable Airplane Wing

(71) Applicant: FLECK FUTURE CONCEPTS GMBH, Munich (DE)

(72) Inventor: John BRWON, Munich (DE)

(21) Appl. No.: 16/873,837

(22) PCT Filed: Jan. 18, 2018
(86) PCT No.: PCT/EP2018/051198

§ 371 Date: Jul. 20, 2020

(51) Int. Cl. B64C 3/56; B64C 3/18; B64C 19/00

(52) U.S. Cl. CPC B64C 3/56; B64C 19/00; B64C 3/185

(57) ABSTRACT

Automatable combination of condensable telescopic or accordion-like wing skin and/or ribs with an unsegmented spar or spars, said components being space-efficiently stowable substantially within the planform of a fuselage, said spar(s) being rotatable from a stowed position substantially parallel to a fuselage to a deployed position for flight substantially perpendicular to a fuselage, and said condensed skin and/or ribs being expandable and deployable with said spar to form an aerodynamic wing.

### TECHNICAL FIELD

The present invention relates generally to the field of airplane construction and, more particularly, to space-economical stowage of airplanes, auxiliary wings for aircraft and/or enablement of use of an airplane as a road vehicle.

### BACKGROUND OF THE INVENTION

Airplanes' wings make them unwieldy when storing and maneuvering them on the ground. They are generally too wide be moved beyond airports via roads. Wind and abrasive weather behoove hangars for their storage at airports. In many cases, hangar rental is the largest operating cost incurred by airplane owners. In a typical general aviation hangar, airplanes are stored with wings and fuselages angled around each other in close proximity with minimum separation, often resulting in minor collisions and surface damage when being moved. Gliders are sometimes hung from the ceiling above the other airplanes or their wings are detached and stored outside in an enclosed trailer or towed via road to a remote storage location. At sea on aircraft carriers where storage space is even more confined, overall wing planform reduction is an even greater priority. Urban aircraft with VTOL capability are likely to require space-efficiently stowable wings deploying for or between landing and takeoff phases. And roadable aviation has the added challenge of stowing wings within the confines of a compact passenger automobile to fit in a standard parking space or garage. Compromises made to reduce wing size for this purpose have led to high stall speeds WO2012012752 (FAA Docket 2014-0935) and even accidents with injuries WO2016057003 (LNVU Report SKS2015011), thus raising safety issues.

For these and other reasons, wing reduction technologies such as swinging, folding, telescopic or accordion-like wings have been envisaged, the latter three employing segmented spars, thus compromising structural integrity and precluding certification for non-experimental, commercial use. Whereas aircraft carrier operations are military and are therefore not subject to civilian certification rules, without an integral, unsegmented spar, even with modern materials, civilian airplanes are likely to remain experimental and therefore non-commercial for the foreseeable future. This may also explain why roadable aviation has yet to be commercialized.

### Specific Background Documents (Prior Art)

Modular Wing Assembly

Saunders GB191419516 teaches insertion of an unsegmented spar into non-telescopic wing segments consisting of ribs and wing surface.

Accordion-Like Wings Stowed Wholly or Partially at a Fuselage

Accordion-Like Elements Between Ribs Perpendicular to a Spar when Deployed

Weis U.S. Pat. No. 1,392,669 p. 1 lines 45-55, Wiesen GB191000236 p. 1 lines 6-23 FIG. 1 & Claim 1, Moore U.S. Pat. No. 1,495,029 & U.S. Pat. No. 1,674,338, and Kurelic U.S. Pat. No. 1,578,740 FIGS. 1 & 4 teach an accordion-type wing having a spar comprising multiple segments.

Accordion-Like Elements Parallel to a Wing-Spar when Deployed

Adams U.S. Pat. No. 1,888,418 FIGS. 84 & 86 teaches accordion-type wing elements which extend back from a spar toward the trailing edge.

Accordion-Like Elements Parallel to a Wing-Spar when Rotated for Flight

Amici U.S. Pat. No. 1,373,934 FIG. 3 & U.S. Pat. No. 1,358,915, Blomeley US20110036938 and Ji et al US2017283035 teach accordion-like elements between primary and auxiliary spars whereby the spars rotate from a stowed position parallel to a fuselage to a deployed position perpendicular to a fuselage. Blomeley addresses the issue of the skin's alternate stretching and bunching in each position.

Telescopic Wings

Whole Wing Stowed Wholly or Partially at Fuselage, Elements Perpendicular to Spar

Tubbe U.S. Pat. No. 1,731,757 at FIG. 9, Jezek U.S. Pat. No. 1,756,463, van de Putte U.S. Pat. No. 1,762,002, Burri FR921308, Ballmann U.S. Pat. No. 2,038,337, Gibson U.S. Pat. No. 2,423,095, Emmi U.S. Pat. No. 2,743,072, Hopwood U.S. Pat. No. 3,162,401, Zielinski DE1925520 FIG. 5, Lukanin RU2169085, Zhang CN2467345, Hegger EPI 541465, Milde U.S. Pat. No. 6,892,979 FIG. 6, Bousfield U.S. Pat. No. 7,866,610, Barbieri U.S. Pat. No. 9,010,693, Hamilton et al US2004069907 & US2005056731, and Zhao et al CN104176238 teach a telescopic wing.

Whole Wing Stowed Wholly or Partially at Fuselage, Rotating, Condensed Elements Deploy Perpendicular to Spar

Sarh U.S. Pat. No. 7,789,343 rotates the wing partially to achieve sweep. Leistner DE2357628 FIG. 2 and Liu CN1948084 FIGS. 2-5, upon retraction, rotate the wings downward flush with the side of the fuselage for stowage.

Whole Wing, Condensed Elements Deploying Parallel to Spar

Adams U.S. Pat. No. 1,888,418 FIG. 87 No. 75 and Aimé, U.S. Pat. No. 2,596,436 FIGS. 9, 10, 16 teach telescopic segments which extend back from a spar toward the trailing edge.

Whole Wing Stowed Wholly or Partially at the Fuselage, Rotating, Condensed Elements Deploying Parallel to Spar

Ortell, U.S. Pat. No. 4,106,727 teaches a main spar rotating around a fixed pivot on a fuselage, said spar having an aerodynamically-shaped telescopic cavity into which smaller non-aerodynamically-shaped telescopic segments attached to subsidiary spars retract, said subsidiary spars having pivots which move along a fuselage. (For purposes of variable in-flight sweep rather than stowage, Arena U.S. Pat. No. 5,312,070 teaches a rotation of aligned spars more similar to the invention, but with separate winglets rather than with telescopic elements forming an airfoil only when combined at full deployment.)

Wingtip Portion, Non-Rotating, Condensed Elements Deploy Perpendicular to Spar

Mandrich U.S. Pat. No. 1,772,815, Adams U.S. Pat. No. 1,888,418 FIGS. 23, 66 & 78, Bellanca U.S. Pat. No. 1,982,242 & U.S. Pat. No. 2,222,997, Hayden U.S. Pat. No. 2,056,188, Fitzurka U.S. Pat. No. 2,249,729, Chapman U.S. Pat. No. 2,292,613, Fleming U.S. Pat. No. 2,294,367 p. 1 line 51, Koch U.S. Pat. No. 2,344,044, Murray U.S. Pat. No. 2,487,465, Makhonine U.S. Pat. No. 2,550,278, Kapenkin U.S. Pat. No. 2,858,091, Ragland U.S. Pat. No. 3,072,364, Crist U.S. Pat. No. 3,086,730, Gioia et al U.S. Pat. No. 3,672,608, Gioia U.S. Pat. No. 4,691,881, Knowles U.S. Pat. No. 6,834,835, Levine et al U.S. Pat. No. 7,832,690, Skillen US20110001016, and Yang CN104943850 teach a telescopic wingtip extension.

Wingtip Portion, Rotating, Condensed Elements Deploy Perpendicular to Spar

Shengjing et al CN102530238 rotate the wing partially to achieve sweep. Aubert DE1034618 rotates the wings rearward for stowage above the fuselage.

Wingtip Portion, Non-Rotating, Condensed Elements Deploy Parallel to Spar

Adams, U.S. Pat. No. 1,888,418 FIG. 87 No. 75 and Aimé, U.S. Pat. No. 2,596,436 FIGS. 9, 10 & 16

Portion of Wing, Rotating, Condensed Elements Deploy Parallel to Spar

Hill et al, U.S. Pat. No. 2,670,910 teach a longitudinal telescopic segment for the flap only which rotates outwardly from a point on the fuselage to achieve forward sweep for landing or slow flight. Look et al U.S. Pat. No. 3,666,210 teach rotation of the rear portion of a wing's ribs into telescopic cavities. MacDonald GB454556 teaches rotation of an inner wing segment at a wing's trailing edge around a point near mid wing, deploying from and to a telescopic cavity in the trailing edge of the main wing to increase wing area. Zieger U.S. Pat. No. 6,073,882 teaches forward rotation of telescopic segments at the wing tip.

Generally, multiple telescopic segments across a whole wing aim for economy of space, whereas telescopically extending portions of a wing aim for increased wing area to enhance lift during landing, take-off or other low-speed flight phases.

All foregoing prior art employs a wing spar which is segmented into two or more segments.

Inflatable Wing

Goodyear U.S. Pat. No. 3,106,373 and Ritter et al U.S. Pat. No. 2,886,265 inflate a whole airplane including its wing. Elam U.S. Pat. No. 7,185,851 inflates a whole wing. Ritter et al U.S. Pat. No. 2,886,265 only inflate a wingtip. Priddy U.S. Pat. No. 4,725,021 inflates a wing's body at lower pressure than its spar. Rugeris GB2315054 inserts an inflatable spar into rigid ribs.

With Telescopic Segments

Butler et al U.S. Pat. No. 3,463,420 combine an unsegmented, swinging leading edge with a telescopically extending trailing edge having inflatable panels forming the wing body.

Wash-Out (Reduction of Angle of Incidence Toward Wingtip)

Wash-out in connection with telescopic wings could not be identified in prior art.

Steering—Wing Warping

Contrary to popular opinion, wing-warping was not pioneered by the Wright Bros. U.S. Pat. No. 821,393. Infringement proceedings held that wing warping was an ancient art pioneered by others and awarded the Brothers protection only for a combination of wing warping with a vertical rudder (Claim 11). Ailerons were Pioneered by Boulton GB1868000392 and Mouillard U.S. Pat. No. 582,757 (1892). Wing warping was pioneered by Le Bris FR1857 and Lamson US666427 (1900).

Steering in Connection with Accordion-Like Wings

Righi DE1016568 teaches an accordion-like wing having an aileron.

Steering in Connection with Telescopic Wings

Steering Surfaces on Wholly Extendable Wings

Ellingston U.S. Pat. No. 1,904,281, Calkins U.S. Pat. No. 3,065,938, Sarh U.S. Pat. Nos. 4,881,700, 4,824,053 & 4,986,493, Rähmer DE19907791, and McCoy WO2016122486 teach ailerons attached to the tip portions of wholly-extendable wings.

Steering Surfaces on Extendable Wingtips

Look et al U.S. Pat. No. 3,666,210 FIGS. 1-13 teach an extendable outer wing segment of approximately half chord-width with an attached aileron. Hall U.S. Pat. No. 1,653,903, Asbury U.S. Pat. No. 2,076,059, Martin U.S. Pat. No. 2,081,436 & U.S. Pat. No. 2,231,524, Harris U.S. Pat. No. 2,260,316, Kraaymes U.S. Pat. No. 2,420,433, Gerhardt U.S. Pat. No. 4,181,277, Gevers U.S. Pat. No. 6,098,927, File US20090206193, Sanderson US2010148011 teach a telescopic tip portion of full chord width with an attached aileron. Makhonine U.S. Pat. No. 2,550,278 and Jensen U.S. Pat. No. 1,833,995 FIG. 2, p. 1 line 19 teach an aileron attached to a wing segment, both of which extend telescopically. Dhall U.S. Pat. No. 7,762,500 FIGS. 3 & 4 & U.S. Pat. No. 8,439,314 teaches an accordion-like, segmented spar structure inside telescopic elements with small aileron segments attached to each of many individual telescopic elements located proximal to the outer wing. Bellanca, U.S. Pat. No. 2,222,997 teaches control via tilting the central, longitudinal element of a three-pronged, extending wingtip.

Steering Surfaces on Extendable Wingtips, Rotated for Stowage

Easter US2011/0036939 teaches a single telescopic wingtip element with an attached aileron and an additional extendable-wingtip aileron on a turntable-type wing which is rotated for stowage under the fuselage. O'Shea US20100282917A1 FIG. 1 teaches telescopic tip portions of biplane wingtips which rotate for stowage, one above and the other below a fuselage, each with an attached aileron.

Steering in Connection with Pitching of Non-Extendable Wings or Wing Elongations

Hunkemöller FR395653 FIGS. 4 to 10 teaches altering the angle of attack of a separate control surface placed at the tip of each biplane wing. The Short Bros. GB1910002614 teach using small airfoils to mechanically alter both the angle of incidence of the wing's airfoil and, by combination of their form with the wing's airfoil, to alter the shape of the airfoil in the manner of a flap or of a slat. Burnelli U.S. Pat. No. 1,774,474 teaches a non-extendable wing with a fenced outer segment where the shape of the airfoil segments at the tip can be changed at their front and rear to increase or decrease camber. A tip segment consisting of two (Messerschmitt GB1929355941 & Medvedeff BE371661) or three (Thurston U.S. Pat. No. 1,775,977) consecutively-mounted airfoils adjusts their relative positions to alter the overall camber of the tip segment.

In U.S. Pat. No. 3,415,469, Spratt teaches effecting roll by asymmetrically pitching an entire, non-extendable wing around strut-mounted pivot joints which are substantially in line with the wing's spar. Cox et al US20050118952 in FIG. 12b, teach control via tilting a non-extendable wing segment located near mid-wing around its spar-line thus acting as a full-chord aileron.

Alfaro U.S. Pat. No. 1,858,259 in Claim 1 teaches a “wing with an aileron positioned entirely beyond the tip thereof”. Martin GB472845 teaches an aileron as an elongation of the tip of the wing's spar, as does Morane-Saulnier FR1207944.

Deployment of Wings without Collision of Spar Stubs

Non-Rotated Deployment

Jezek U.S. Pat. No. 1,756,463 and Dhall U.S. Pat. No. 8,439,314 FIG. 27 teach telescopic wings which retract into a fuselage asymmetrically: Jezek at different heights; Dhall at different points longitudinally on the fuselage. Melton et al U.S. Pat. No. 9,327,822 swing a turntable wing during flight thus illustrating the principle that asymmetric positioning of wings along the fuselage, while having an unusual appearance, is not at odds with flight physics.

Rotated Deployment

Blume DE692060 and Perl U.S. Pat. No. 2,573,271 teach rotation of whole wings, and Dhall U.S. Pat. No. 8,439,314 FIGS. 1-26 of telescopic wings, from a position substantially parallel with the fuselage to a position substantially perpendicular to the fuselage, deploying them for flight asymmetrically at different heights, thus avoiding a collision of the spar root portions (stubs) during rotation. Brown U.S. Pat. No. 9,259,984 FIGS. 3 A-E teaches extension of whole wings from parallel to perpendicular, each supported by rotation points located at the same height. Collison of the spar root portions is avoided by skewing the wings at an angle to each other during rotation. Once perpendicular, the wings are then levelled to a symmetrical position.

### Technical Problems to be Solved

The problem to be solved involves reconciliation of issues of dynamic geometry on the one hand with issues of flight physics on the other hand. On the one hand, economy of space dictates that an unsegmented spar (and any auxiliary spars) must be stowed substantially parallel to and substantially within the plan-view confines of an airplane's fuselage, i.e. perpendicular to its position when deployed for flight. On the other hand, automation dictates that an unsegmented spar (and any auxiliary spars) must rotate from parallel to perpendicular in a manner which can be supported by the structure attached to it, and that it come to rest along (and in the case of auxiliary spars near to) the line at which the strongest aerodynamic forces occur known as the wing's center of lift where it/they must then be securely braced.

The inside of the wing of a light aircraft is mostly empty space except for ribs, steering-rods, cables and fuel tanks. If tanks are re-located to the fuselage, reducing the volume of a wing for stowage purposes by compressing empty space inside without compromising structural strength, defines a further part of the technical challenge.

Rather than store all of a wing's main components (spar, ribs & outer surface) individually and assemble them from scratch before each flight, the present invention allows the ribs and surface to be tightly condensed separate to or in partial conjunction with the spar. Prior to flight, the spar and said ribs & surfaces are realigned causing them to expand outwardly to form a wing in a movement which can be automated.

To facilitate a solution to the problem, the wings are placed asymmetrically at differing heights or differing lengths on each side of the fuselage thus allowing the roots of the spars to rotate past each other without colliding. Although these arrangements may appear aesthetically unbalanced, there is no disbalance in terms of flight physics, except marginally when operating the airplane in ground effect where a slight roll movement away from the lower wing (if mounted at different heights) or away from the rear wing (if mounted at different lengths) can be easily countered. If desired, means can be provided for levelling wings placed at different heights.

FIGS. 6A-E illustrate the scope of the problem. Even with an unusually wide fuselage as shown here which is approximately twice the normal width (thus causing higher profile and parasite drag), and with an unusually stubby wing as shown here which has approximately half the normal aspect ratio (i.e. it has a shorter span relative to its chord or rib-length), thus increasing induced drag, the task of inserting an unsegmented spar into telescopically-expanding wing segments in an automatable way (i.e. while attached to the fuselage) intrudes into key components of the wing's structure, thus compromising their integrity and strength. This can be seen most clearly and is highlighted with an airfoil cross-section in FIG. 6C where the spar, in order to fit inside the telescopic element, can only be half as high as it would normally be, thus decreasing its ability to bear flight loads. Furthermore, during rotation the spar traverses the length of the third rib via a cavity which stretches from the center of lift (on average about ⅓ of the distance from the rib's leading edge) to just under the surface at a point about ¼ of the distance from the rib's trailing edge. This cavity weakens the rib's structure and its ability to bear torsional loads. Added structural support for the rib can be provided by a trolley which moves along the rib's cavity and has an opening the size of the spar's section through which the spar can move (FIG. 6E). However, the result would be weaker than what a solid rib without such a trolley-bridged cavity would provide. In sum, a lower spar together with cavitous ribs, each of decreased strength, may explain why such a wing structure is not found in prior art. (Nevertheless, increasing strength of synthetic-fiber materials and advances in blended fuselage technologies give cause to seek patent protection for this layout, although further improved solutions are presented subsequently in this application.)

Since the wing is expanded from a condensed state, there is the problem of imbuing it with a graduated angle of incidence known as wash-out (to enhance stall safety) and the problem of providing its tips with means of lateral steering (for roll control).

### SUMMARY

Providing space for airplane stowage and transport is a major operational cost factor which could be respectively reduced and alleviated by condensable telescopic or accordion-like wings. However, the lack of an invention combining an unsegmented spar (i.e., in one piece) with condensable telescopic or accordion-like surface elements, thus enabling their extension into an aerodynamic wing with an integral spar, has, thus far, prevented civil certification of telescopic wing technology for non-military, non-experimental, commercial use. Due to structural, safety and aerodynamic issues, telescopic wings are almost unknown in a practical context, even experimentally.

Prior art teaches many embodiments of telescopic and accordion-like wing structures, albeit embodying segmented spars. Generally, when applied to a whole wing, said structures aim for space economy and provide means for storage proximal to a fuselage. When applied to only a portion of a wing such as a wingtip, said structures generally aim for reduction of wing area to enable high-speed flight. Embodiments exist for telescopic segments both parallel to and perpendicular to a spar, and either with or without control surfaces for roll steering.

Geometry and flight physics are the factors defining the problem of how to incorporate a space-economically stowed, unsegmented spar into a telescopic or accordion-like condensed wing surface structure. Further problems are how to imbue such wings with wash-out and control surfaces for lateral steering.

### DISCLOSURE OF THE INVENTION

The present invention improves on prior art by combining a solid, integral, unsegmented wing spar (rather than a structurally weaker, segmented spar) into a space-economical condensed arrangement of wing ribs and wing skin or surface(s) stowed proximal to a fuselage, and in an automatable manner rotating said spar from a space-economical stowed position substantially parallel to said fuselage to a position substantially perpendicular to said fuselage in its deployed position, and combining said ribs and wing skin with said spar when deployed to form an aerodynamic wing which can bear flight loads.

In one non-restrictive embodiment, during its rotation from its space-economical stowed position substantially parallel to a fuselage, to its flight position substantially perpendicular to said fuselage, an unsegmented spar is inserted into a telescopically or accordion-like condensed package of ribs and wing surface(s), said package having been rotated until an angle is reached at which said unsegmented spar is aligned with the holes in said ribs or is perpendicular to said ribs (or substantially perpendicular, depending on the degree of any wing-sweep). At this point said unsegmented spar is inserted into said package of ribs and skin along the line of the peaks of said ribs' airfoil-shaped segments (i.e. along the approximate mid-range of the center of lift where the greatest lifting force is exerted), snugly fitting through said holes in each said rib in a manner consistent with the state-of-the art of wing construction. During insertion, both said spar and said rib/skin-package rotate, continuously aligning themselves to allow direct insertion of said spar into said ribs. Once said spar-insertion-movement has been substantially completed, a thus-assembled aerodynamic wing is rotated onward to its final deployed position for flight.

Providing wash-out along the length of a thus-assembled wing and means for lateral steering at its tips is achieved by embodiment of steps of successively reduced cross-section along said spar's length from its root to its tip and accompanying reduction of the size of said holes in said ribs through which it passes. To achieve wash-out, the inner steps on said spar have a higher angle of incidence than the outer ones so that the ribs into which they are fully inserted for flight each assume the appropriate angle of incidence required for wash-out (near the root, higher, near the tip, lower).

To achieve roll control, the outer layer of each of said steps located near said spar's tip is detached to form a sleeve or sleeves revolving around a rounded core portion of a spar. By rotating the outermost sleeve, the neighboring inner sleeves and the ribs and surfaces they support change their angle to the oncoming airflow, thus effecting roll.

In another non-restrictive embodiment, condensed telescopic rib/skin elements into which a auxiliary spar has been partially inserted, are stowed within the outer portion of a wing or ‘host wing’ having a main spar and a gap in its inner portion in an area where a auxiliary spar would normally be located. Said auxiliary spar and said telescopic rib-skin package together with said host wing rotate from their stowed positions proximal to a fuselage, to positions substantially perpendicular to a fuselage, whereupon said auxiliary spar inserts into said telescopic rib/skin elements to fill said gap in said inner portion of said host wing.

In yet another non-restrictive embodiment, wing surface elements are attached to main and subsidiary spars such that the surface element of said main spar telescopically envelopes the spars and attached surfaces of auxiliary spars when placed close together for stowage. When rotated via staggered-placed pivots through approximately ninety degrees, said spars spread apart to deploy for flight such that the space between said main and said auxiliary spars is larger and enclosed within said telescopic surfaces which form an aerodynamic wing for flight.

In yet another non-restrictive embodiment, a telescopic wing surface and wingtip portion are attached to a main spar rotating on or near a fuselage and via a pivot to a condensed package of ribs and telescopic wing surfaces attached via a sleeve pivot to a auxiliary spar or spars attached via a pivot to a trolley running along a rail on or near a fuselage. Said spars are stowed substantially parallel to a fuselage and are rotated in two directions to deploy substantially perpendicular to said fuselage. When deployed said spars and attached or expanded surfaces and ribs form an aerodynamic wing.

The novel, innovative steps employed and the unity of invention of those steps with the main invention, and how they improve on prior art are explained below:

Condensable Wing-Ribs/Skin with Unsegmented Spar

The first novel, innovative step is the combination of an unsegmented wing spar with condensable telescopic or accordion-like rib-&-skin structures. This first step stands alone (see FIGS. 1-5 which show an unsegmented spar combining with telescopic or accordion-like rib/skin elements to form an aerodynamic wing). This combination is unknown in prior art.

Rotation of Stowed Spar from Parallel and Proximal to Fuselage to Perpendicular

The second novel, innovative step is the combination of said first step with the rotation of a spar or spars from a stowed position substantially parallel and proximal to a fuselage to a deployed position for flight substantially perpendicular to a fuselage.

Automation of Deployment of Condensed Ribs/Skin and Unsegmented Spar

The third novel step is the accommodation of said first two steps within a supporting structure enabling its automation.

Automatable rotating spars as described in steps two and three are unknown in prior art for telescopic wings with unsegmented spars as described in step one. Together, said three aforesaid steps comprise the Main Claim.

Automatable, Laterally-Expanding Condensable Wing-Ribs/Skin with Rotatable Insertable Spar

An non-restrictive example of the embodiment of the first three steps is shown in FIG. 6. Here, a root part of a telescopic or accordion-like rib/skin-package is fixed substantially in line with a fuselage so that its expansion can only be effected in one direction laterally away from the fuselage along the line of a conventional unswept wing in a spanwise trajectory (see FIGS. 6 A-D). An unsegmented spar is stowed separately at an approximately perpendicular angle to said package, substantially in line with and for reasons of space-economy substantially parallel to and substantially within the plan-view confines of said fuselage. Said spar extends via a motion whereby it is inserted into elongated cavities in said ribs (see FIG. 6 C) and is rotated through approximately ninety degrees between its stowed and its flight-deployment positions. Said spar is supported throughout said motion by a sub-structure, thus enabling automation. Said elongated rib cavities can be bridged by a trolley through which the spar passes (FIG. 6E). These steps improve on prior art by deploying an unsegmented spar in telescopic wing elements, each having been previously stowed in a space-economical manner.

Rotatable Condensable Wing-Ribs/Skin with Rotatable Unsegmented Spar

In a fourth step, not only an unsegmented spar but also a telescopic or accordion-like rib/skin-package rotate during automatable deployment (see FIGS. 7A-D and 8A-D. (FIG. 7 shows rib/skin segments with rigid surfaces. FIG. 8 shows an accordion-like rib/skin package with fabric or synthetic skin.) In this step, the condensed telescopic or accordion-like rib/skin-package is fixed only at its leading edge (or in case of an aft-mounted wing, at its trailing edge) at or near a fuselage via a pivot, thus allowing it to rotate away from said fuselage until it reaches an angle at which the unsegmented spar which has also been rotated until it reaches an angle perpendicular to the rib/skin-package is insertable in a straight line through holes in said ribs which are sized for structural reasons to snugly accommodate said spar section (along with any attachments such as steering rods). The unity of invention derives from the means for this fourth inventive step only being present when the first three steps are given. This step improves on steps one to three and the previously described embodiment by automatably deploying telescopic wing elements and an unsegmented spar from a more space-economical stowage position at a narrower fuselage, and by enabling a stronger (higher) spar and stronger (fuller) ribs to be employed.

Wash-Out for Wing-Ribs/Skin-Package Expanded by Insertable Spar

In a further novel and inventive fifth step, the size of a hole in each rib through which a spar is inserted is reduced from rib to rib progressing outwardly away from its root to its tip. The cross-section of said spar reduces accordingly step-wise at each said rib so that said spar fits snugly into said holes in said ribs when fully deployed. This step-wise outward reduction of spar cross-section complemented by according reduction of rib hole size enables accommodation of wash-out. (Wash-out is a wing construction method whereby a wing's angle of incidence shallows from its root to its tip. This is done to mitigate control loss during an incipient stall by causing airflow separation at a wing's inner portion first, thus leaving lateral steering (ailerons) on its outer portion with airflow and therefore with a means of control for recovery.)

By slightly angling said larger holes in said inner ribs backward and said smaller ones in said outer ribs forward (and angling said complementary cross-sections of said spar accordingly), the thus-assembled wing is imbued with wash-out (see FIGS. 10A-B). The unity of invention derives from this step only being relevant in the context of steps one, four and five. This step improves on prior art by providing wash-out to a telescopic or accordion-like expandable wing.

Roll Control for Wing-Ribs/Skin-Package Expanded by Insertable Spar

In a further novel and inventive sixth step, an outer portion of an unsegmented spar together with an outer segment or segments of a rib/skin-package expanded thereon, are used as a means of lateral steering to effect roll. FIGS. 11A-C illustrate this step as applied to three outer ribs and accompanying outer skin and unsegmented spar portions. The cross-section of said outer portion of said unsegmented spar is reduced to a circular beam around which a rectangular sleeve or sleeves rotate. Said sleeve/s occupy the space filled by cross-sections in the previous step five and fit snugly into holes in each rib while allowing said ribs' leading and trailing edges to rotate respectively upward and downward and the skin or surfaces they bear to alter their angle of incidence. If solid telescopic airfoil segments are employed, each will have a slightly different angle of incidence to the oncoming airflow increasing or decreasing in graduation toward the wingtip, when deployed to effect roll. If a natural or synthetic skin is used, the arrangement resembles wing warping. The unity of invention derives from this step only being relevant in the context of steps one, four and/or five. This step improves on prior art by providing means for applying the ancient art of wing warping to a telescopic wing, and by providing a telescopic wing with a means of reducing the size of an outer wing portion, upon which an accordion-like steering surface or co-active telescopic surface segments are placed.

Means for mechanically manipulating telescopic surface elements or accordion-like skin surfaces at an outer wing to effect roll control via a steering rod are shown in FIG. 12. Said steering rod is mounted closely attached to and along said unsegmented spar and is inserted through said holes in said ribs, said holes having been enlarged only as much as needed to allow said steering rod to pass through them.

Condensable Wing-Ribs/Skin & Spar within Perpendicular Stowed, Rotatable Wing

In a further novel and inventive step, condensed telescopic rib/skin elements which are partially inserted into an auxiliary spar, are stowed within the outer portion of a wing or ‘host wing’ having a main spar and a gap in its inner portion in an area where an auxiliary spar would normally be located. Said auxiliary spar and said telescopic rib-skin package together with said host wing rotate from their stowed positions proximal to a fuselage, to positions substantially perpendicular to a fuselage, whereupon said auxiliary spar inserts into said telescopic rib/skin elements to fill said gap in said inner portion of said host wing (see FIGS. 13A-C). Said arrangement is specific to the purpose of stowage of a rotatable wing along a fuselage over and/or around a protrusion such as a cabin and is unknown in prior art.

Telescopic Elements Attached to Rotating Main and Subsidiary Spars

In a further novel and inventive step, telescopic wing segments are deployed longitudinally along rotating unsegmented spars (rather than laterally on ribs which expand outwardly along a spar, as in steps four to six). Said rotating spars are stowed substantially parallel and proximal to a fuselage with little or no space between them and their rotation points are staggered such that when they are deployed substantially perpendicular to the fuselage, they line up as primary and auxiliary spars with a usual amount of space between them. When deployed, said telescopic elements attached to said spars cover the thus-expanded space between said spars in a manner which forms an aerodynamic wing (see FIGS. 14A-C).

Due to skin-stretch and -bunching issues, this step is less appropriate for accordion-like natural or synthetic fabric wing surfaces and would need to be accompanied by a slack roll-up capability, multi-directional hyper-stretch fabric or both).

Combination of Rigid Telescopic Element Attached to a Rotating Main Spar with a Rib/Skin-Package of Expandable Elements Attached to a Rotating Auxiliary Spar

In a further novel and inventive step, a mostly telescopic wing surface with an enclosed (non-telescopic) wingtip portion is attached longitudinally to a rotating unsegmented main spar. Said rotating main spar is stowed substantially parallel and proximal to a fuselage and attached via a pivot to a condensed package of ribs and telescopic surfaces or ribs and accordion-like skin. Said package is attached via a pivot to a rotating auxiliary spar (or spars). Said auxiliary spar/s is attached via a pivot on a trolley in a rail to said fuselage, said rail being substantially parallel to said fuselage and said auxiliary spar/s being stowed substantially parallel to said fuselage. Movement of said auxiliary spar/s along said rail pushes against said package causing it, said attached main spar and said auxiliary spar/s to rotate outward and away from said fuselage until a point is reached at which said package is perpendicular to said auxiliary spar whereupon said auxiliary spar inserts into said package. At this point, rotation of said spars continues in the opposite direction during which said package is expanded by continued insertion of said auxiliary spar. The rotational movements conclude with said spars substantially perpendicular to said fuselage, said package fully expanded and an aerodynamic wing formed (see FIGS. 15A-J).

Prior art variously combines non-aerodynamically-shaped surfaces, mere portions of a wing and sliding spar-rotation points for the purpose of wing area reduction to enable high-speed flight. The present invention improves on prior art by combining the assembly of an aerodynamic shape for a whole wing comprising rotating spars supported at fixed, non-sliding points for the purpose of space-economical stowage.

Nothing in this brief description of the preferred, non-restrictive embodiments should be construed as limiting the scope of the application of the various parts of the invention in other ways or contexts.

### BRIEF DESCRIPTION OF THE DRAWINGS

Characteristics of the invention described above will be clear from the following description of preferential forms of embodiment, given as non-restrictive examples, with reference to the attached drawings:

FIGS. 1-4 show various embodiments of the components of telescopic and accordion-like airplane wings in couplets, respectively before and after they have been rotated through approximately ninety degrees from their stowed positions to their deployed positions. (Said rotations are not shown in these FIGS.)

FIG. 1A is a plan view of an unsegmented wing spar attached to an auxiliary spar (left) and a package of telescopic wing elements consisting of ribs and wing surface (right).

FIG. 1B is a plan view of an unsegmented wing spar attached to an auxiliary spar which has been inserted into and has expanded what had previously been a package of telescopic wing elements consisting of ribs and wing surface such that said elements are spread along said spars to form an aerodynamic wing.

FIG. 2A is a plan view of an unsegmented wing spar attached to an auxiliary spar (left) and a package of accordion-like wing elements consisting of ribs and wing skin of fabric or synthetic covering material (right).

FIG. 2B is a plan view of an unsegmented wing spar attached to an auxiliary spar which has been inserted into said package of accordion-like wing elements and has partially expanded it, in the process spreading the contents of said package along said spars.

FIG. 2C is a plan view of an unsegmented wing spar attached to an auxiliary spar which has been inserted into said package of accordion-like wing elements and has fully expanded its contents along the spars to form an aerodynamic wing.

FIG. 3A is a plan view of a stowed arrangement of three unsegmented wing spars, each of which has rigid telescopic wing surface elements attached to it, said spars being positioned close together with little or no space between them.

FIG. 3B is a side view of said stowed arrangement of said spars with said telescopic elements tightly packed together.

FIG. 3C is a plan view of a deployed arrangement of three unsegmented wing spars, each of which has rigid telescopic wing surface elements attached to it, said spars having been spread such that said telescopic surfaces form an aerodynamic wing.

FIG. 3D is a side view of said deployed arrangement of said parallel spars with said telescopic elements spread out between them to form an aerodynamic wing airfoil.

FIG. 4A is a plan view of an airplane wing without roots, ribs or stringers in its inboard section, i.e., with a “gap” located laterally between its main spar and its landing-flap and longitudinally between its root rib and mid-wing. In a cavity at the inboard edge of its outer wing portion between its main spar and its trailing edge stringer is a condensed package of telescopic elements each consisting of a rib or ribs attached to a rigid wing surface unit into which a large segment of auxiliary spar located wholly within the outer portion of said wing is partially inserted.

FIG. 4B is a plan view of said wing in which said auxiliary spar segment has been inserted into said telescopic elements and has spread them to form an aerodynamic inner wing portion, thus filling the gap.

FIG. 5A is a plan view of an unsegmented mainwing spar with attached telescopic surface and wingtip portion (upper right), and attached package of telescopic wing surfaces and ribs (center), and an auxiliary spar (left).

FIG. 5B is a plan view of said auxiliary spar having been inserted into and expanded said package to form an aerodynamic wing in combination with said main spar.

FIGS. 6-8 show how spars and telescopic or accordion-like elements shown in FIGS. 1-4, can be combined with spars which are rotated from a position substantially parallel and proximal to a fuselage, to a deployed position substantially perpendicular to said fuselage, thus forming a structurally sound aerodynamic wing.

FIGS. 6A-D show plan and front views (6C, shows a side view) of a main wing spar stowed perpendicular to the direction of flight on a relatively wide fuselage typical of a roadable aircraft, said spar being inserted into a package of telescopic wing elements, each element consisting of a rigid wing surface attached to one or more ribs, each rib having an elongated cavity through and along which said spar passes during expansion. The rib/skin-packages are attached at the side of said fuselage in such a way that they cannot rotate and can only expand substantially laterally away from said fuselage.

FIG. 6A shows said rotatable spars and said non-rotatable rib/skin-packages in their stowed position.

FIG. 6B shows said spars partially rotated and said packages partially extended.

FIG. 6C shows said spars' rotation at the point where they require the longest cavity in a rib to be able to pass. FIG. 6C includes a side view of said longest rib cavity.

FIG. 6D shows said rotatable spars and said non-rotatable telescopic packages in their deployed positions.

FIG. 6D shows a side view of a cavity-bridging trolley through which a spar passes and which moves along the cavity, swiveling as it does so to allow said spar to pass.

FIGS. 7A-F show plan and front views of rotatable mainwing spars with attached auxiliary spars stowed perpendicular to the direction of flight on a relatively narrow fuselage. Said spars are being inserted into packages of telescopic wing elements, each element consisting of a rigid wing surface attached to one or more ribs, each rib having holes through which said main spar and said auxiliary spar fit snugly. Said rib/skin-packages are attached at the side of said fuselage in such a way that they can rotate to line up perpendicular to said rotating spars thus enabling said spars to be inserted into said rib/skin-packages snugly and to expand them while rotating onward to their deployed positions.

FIG. 7A shows said rotating spars and said rotating packages in their stowed positions.

FIG. 7B shows said spars and packages at the point of rotation where they are lined up perpendicularly to each other thus enabling snug insertion of said spars into said ribs.

FIG. 7C shows said main spars snugly inserted into three of said telescopic elements.

FIG. 7D shows said main spars inserted into seven and said auxiliary spars partially inserted into five of said telescopic elements.

FIG. 7E shows almost complete spar insertion and the final phase of rotation.

FIG. 7F shows said rotating spars and packages in their deployed positions.

The following drawings show transparent wing surfaces (i.e., not “x-ray views”):

FIGS. 8A-F show plan and front views of a rotatable main wing spar with attached auxiliary spar stowed perpendicular to the direction of flight on a relatively wide fuselage typical of a roadable airplane. Said main spars are being inserted into accordion-like packages of ribs and skin surfaces, each rib having holes through which said main and said auxiliary spars fit snugly. Said rib/skin-packages are attached at the side of said fuselage in such a way that they can rotate to line up perpendicular to said rotating spars to enable said spars to be inserted into said accordion-like rib/skin packages and to expand them while rotating onward to their deployed positions.

FIG. 8A shows said rotating spars and said rotating packages in their stowed positions.

FIG. 8B shows said spars and packages at the point of rotation where they are lined up perpendicularly to each other thus enabling snug insertion of said spars into said ribs.

FIG. 8C shows said main spars partially inserted into said accordion-like packages.

FIG. 8D shows said main spars further and said auxiliary spars partially inserted into said accordion-like packages.

FIG. 8E shows almost complete spar insertion in the final phase of rotation.

FIG. 8F shows said rotating spars and packages in their deployed positions.

FIG. 9A shows a front view of wings mounted at the same height and tilted to allow their stubs to rotate past each other.

FIG. 9B shows a front view of wings mounted at the same height where the wings have been levelled after their spar stubs have rotated past each other.

FIG. 10A shows a side view of an airfoil without wash-out, i.e. with a constant angle of incidence from root to tip.

FIG. 10B shows a side view of an airfoil with wash-out, i.e. with a lesser angle of incidence at the tip than at the root.

FIGS. 11A-C show how roll is effected via varying the angle of incidence of telescopic elements by rotating them around a main spar near its wingtip.

FIG. 11A shows said telescopic tip-elements in a neutral position.

FIG. 11B shows the leading edge of said telescopic tip-elements in a downwardly tilted position of reduced angle of incidence to effect a roll to the left (at normal speeds).

FIG. 11C shows said leading edge tilted upward to effect a roll to the right.

FIG. 12 shows plan, front and side views of a mechanism for roll control via tilting of telescopic segments near a wingtip.

FIGS. 13A-C show plan views of a rotatable host wing and an auxiliary spar within it, which, once rotated, inserts into telescopic elements to cover a gap in said host wing.

FIGS. 14A-C show plan and side views of a main spar with two detached auxiliary spars, each with its own pivot point for rotation and each with telescopic wing surface elements attached thereto. Said spars are rotated from a compactly stowed position substantially parallel and proximal to a fuselage, to a deployed position substantially perpendicular to said fuselage spaced such that said telescopic elements form an aerodynamic wing.

FIG. 14A shows said spars and said telescopic elements in their stowed position.

FIG. 14B shows said spars and said telescopic elements in a position of partial rotation.

FIG. 14C shows said spars and said telescopic elements in their deployed position.

FIG. 15 shows plan, side and front views of a main spar with attached telescopic surface and wingtip portion, attached via pivot to a telescopic rib/surface package attached via a sleeve pivot to an auxiliary spar being inserted therein atop a fuselage, whereby said spars are stowed, rotated and deployed at a two degree dihedral angle.

FIG. 15A is a side view showing how each stub's root lies below its tip when stowed.

FIGS. 15B-C show expansion of said package and counter rotation of said spars.

FIGS. 15F-I show further expansion of said package and co-rotation of said spars.

FIG. 15J shows the deployed position of said spars and said package.

FIGS. 16-18 show how those spars and telescopic or accordion-like elements shown in FIGS. 1-4, which are combined with rotation of those spars shown in FIGS. 6-9, 13 & 14, can be embodied in roadable aircraft.

FIGS. 16A-B show perspective upper front quartering views of a four-wheel and FIGS. 17A-D show three-views of a two-wheel roadable aircraft, each embodying the wing components shown in FIG. 1, and the rotation from stowed to deployed positions and the rigid telescopic skin/rib elements shown in FIG. 7.

FIGS. 18A-D show three-views of a roadable aircraft embodying the wing components shown in FIG. 4 and a rotation of the wing spar shown in FIG. 13.

FIGS. 19A-B show three-views of a roadable aircraft embodying the wing components shown in FIG. 3 and the rotation from stowed to deployed positions shown in FIG. 14.

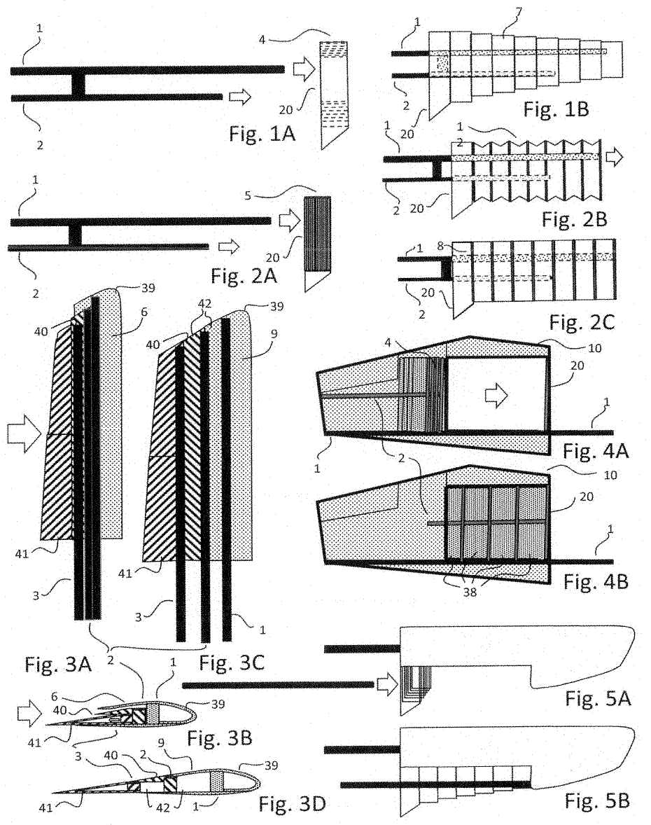

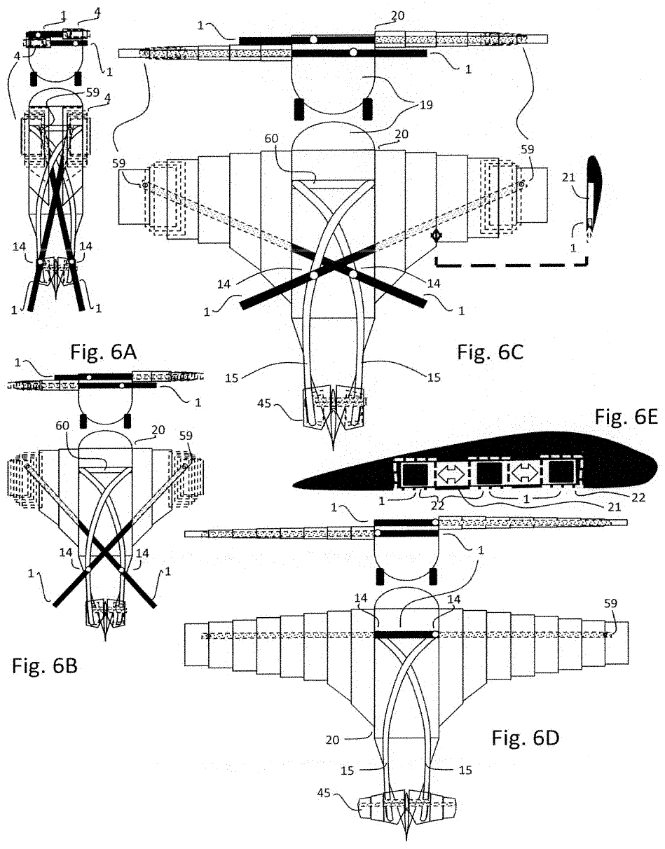

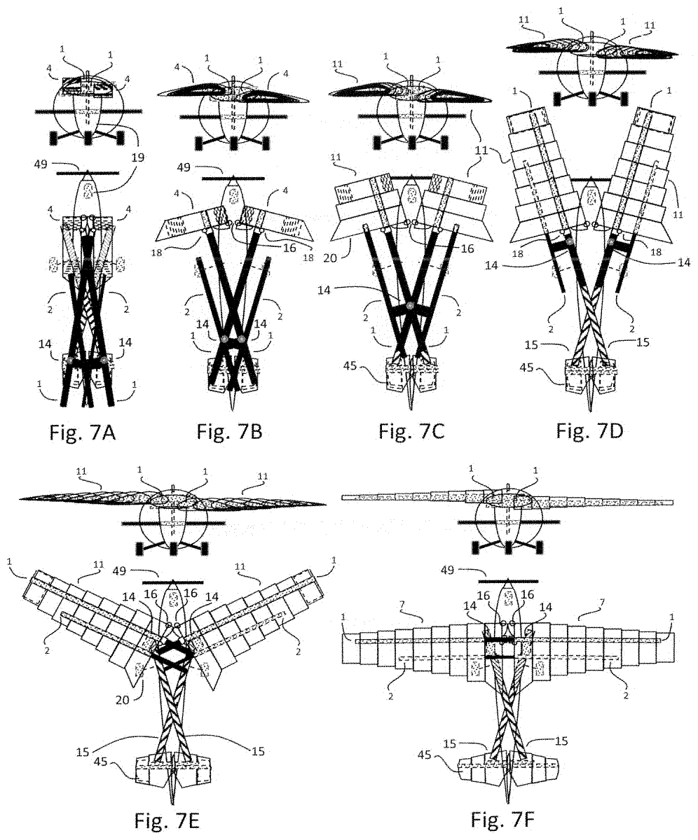

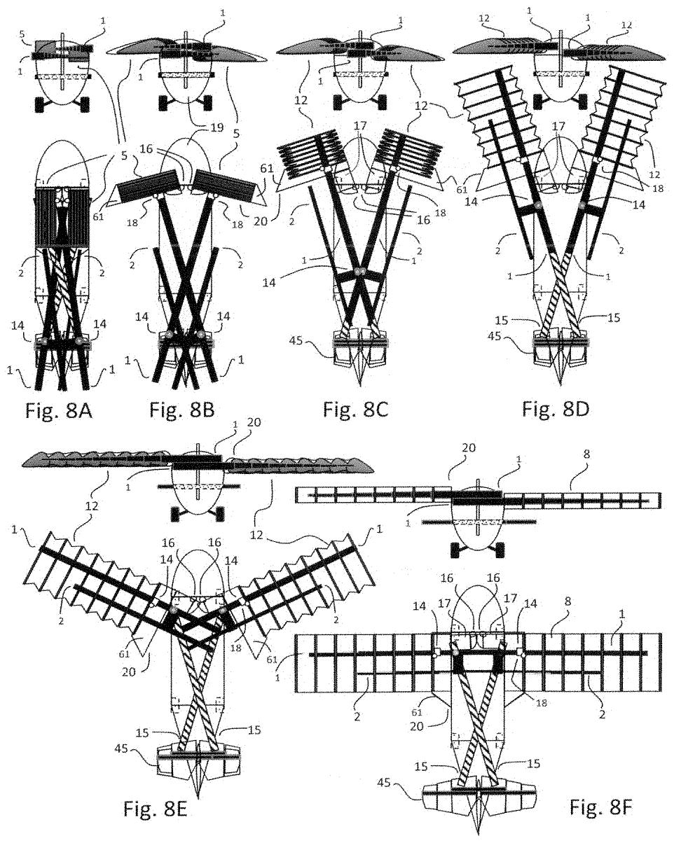

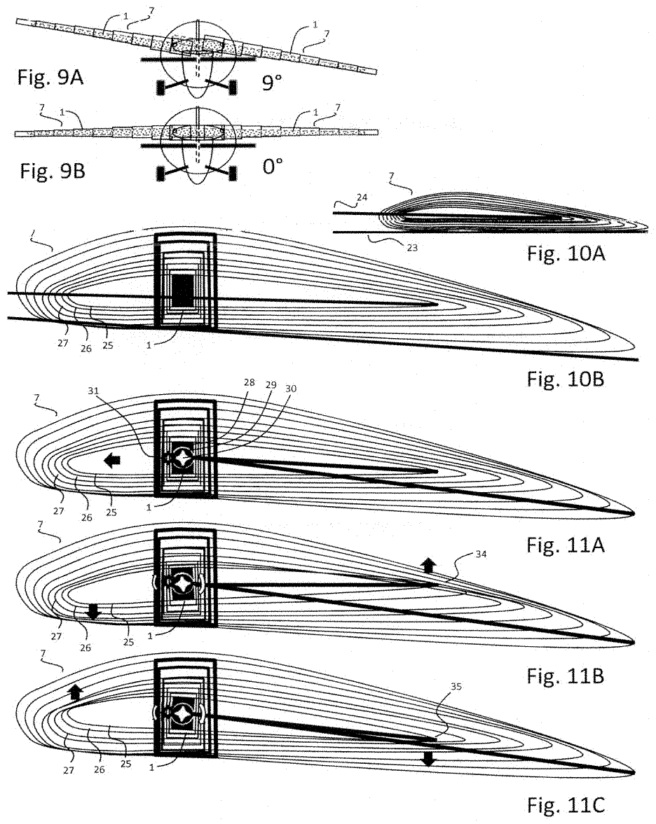

### DETAILED DESCRIPTION

(a Reference Key Denoting the Terms Used Herein is Found at the End of this Section)

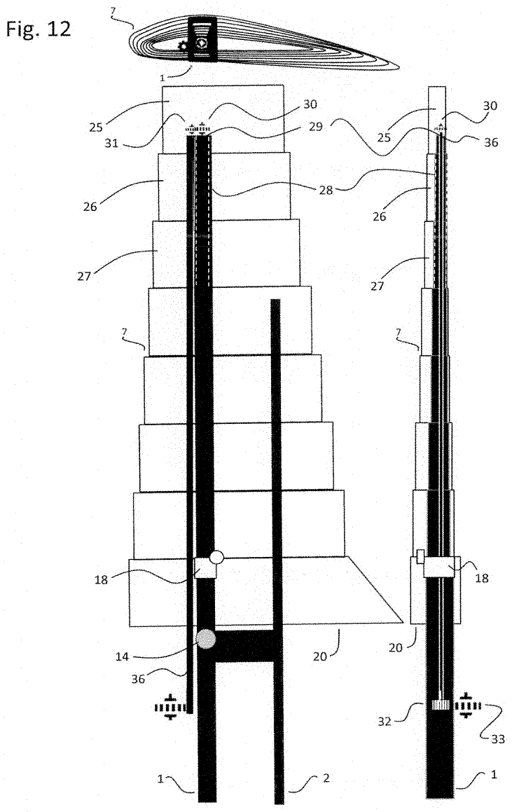

With reference to FIG. 6A, an unsegmented spar 1 having an attached rail pivot 14, said pivot being mounted on a trolley attached to and movable along a rail 15, said rail being attached along and proximal to a fuselage 19, is stowed substantially parallel to said fuselage, such that said rail pivot 14 is at or near one end of said rail 15, and said end of said rail is at or near the same end of said fuselage 19, said rail being either straight or curved. The other end of said unsegmented spar 1 is attached to a wingtip rib spar pivot 59, said rib pivot 59 being attached to the smallest segment of a package of condensed telescopic wing surfaces, each attached to a rib or ribs 4. The root rib 20 of said package 4 is immovably mounted on or near the port or starboard flank of a fuselage 19. Said unsegmented spar 1 is inserted through the cross-section of said package of telescopic wing surfaces and ribs 4, each of said ribs having an elongated cavity 21, each of said cavities having a rib-cavity-bridging-trolley-with-spar-sleeve 22, said trolley being movable via a sliding motion from one end of said cavity to the other, said spar being inserted through each of said bridging-trolley sleeves 22. Referring to FIGS. 6B-D, an automatable movement drives said rail pivot 14 of said spar 1 from one end of said rail toward the other end. Said movement causes said spar 1 to push said wingtip-rib-spar-pivot 59 outward away from said fuselage 19. As said movement continues, said spar 1 inserts further into said package of condensed telescopic wing surfaces 4, expanding it outwardly and away from said fuselage 19. During said movement, said spar 1 rotates from a position substantially parallel and proximal to said fuselage 19, to a position substantially perpendicular to said fuselage 19 and said trolley sleeves 22 through which said spar 1 inserts, move from one end of the elongated rib cavities 21 to the other end, as needed to allow said movement of said spar 1 until an aerodynamic wing 7 has been assembled. The root portion of said spar 1 is braced at a bulkhead 60 for flight.

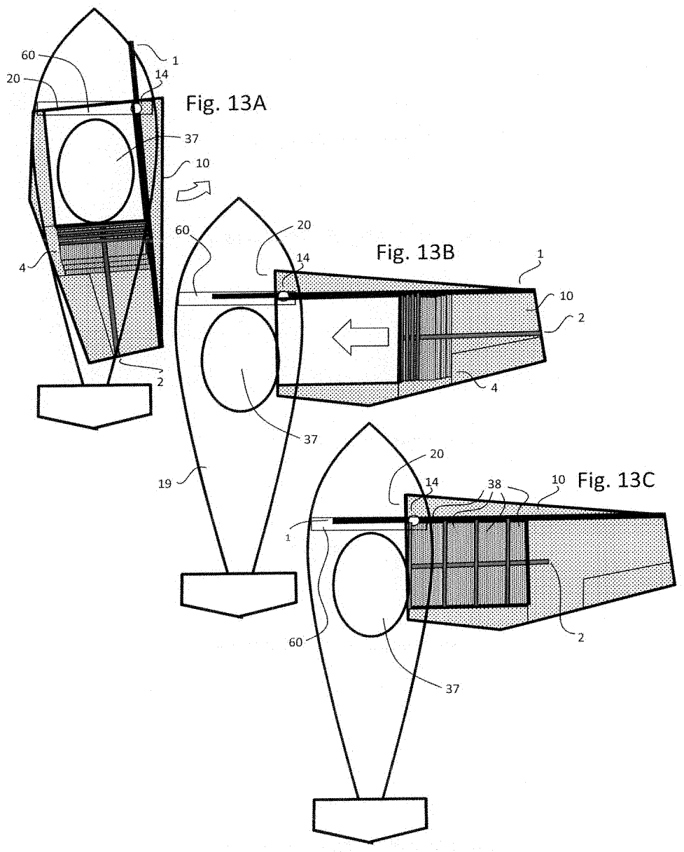

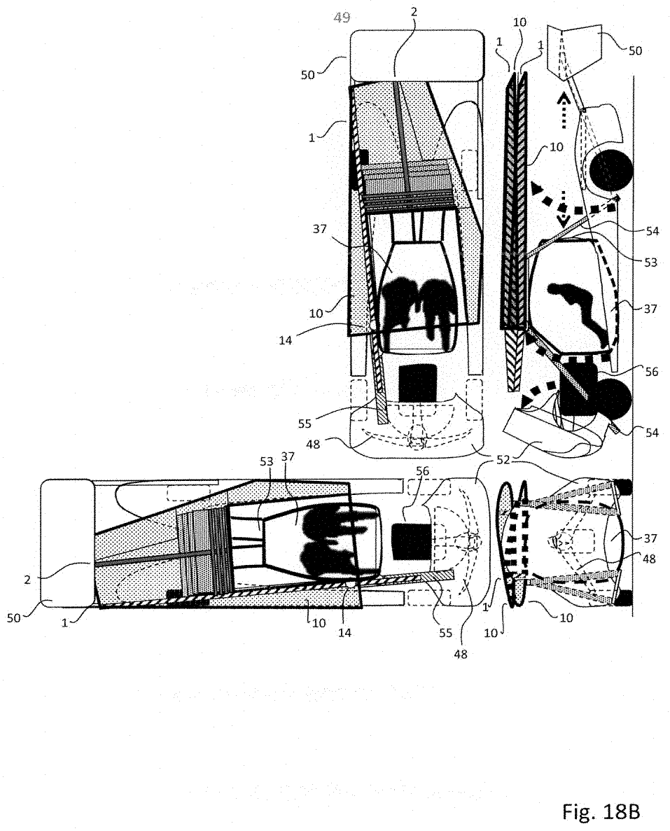

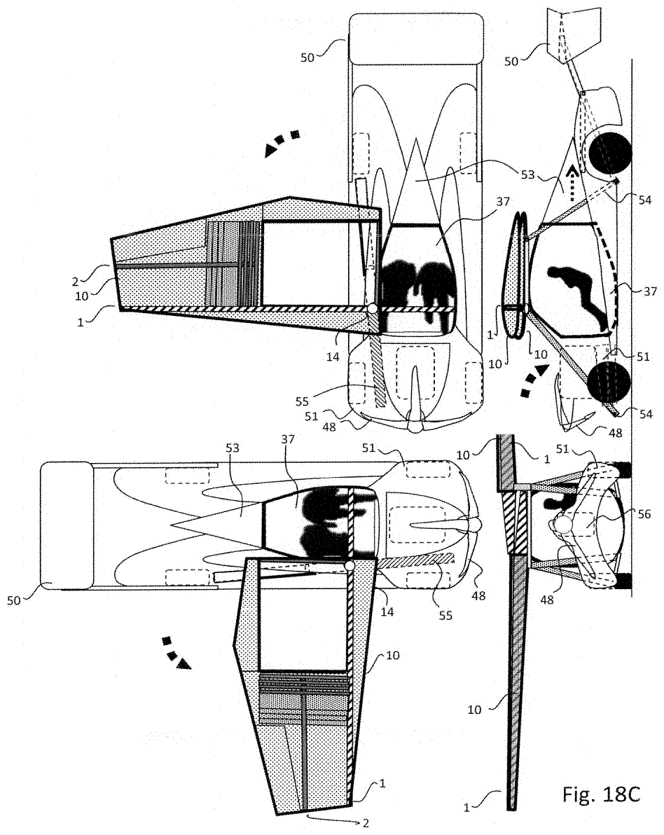

With reference to FIG. 7A, an unsegmented spar 1 which can have an attached auxiliary spar 2 as shown (or more auxiliary spars in other embodiments), having an attached pivot 14, said pivot mounted on a trolley attached to and movable along a rail 15, said rail attached to and movable along and proximal to a fuselage 19, is stowed substantially parallel to said fuselage 19, having its pivot 14 at or near one end of said rail 15, said end of said rail being at or near the same end of said fuselage 19. The other end of said unsegmented spar 1 is inserted in a root rib spar sleeve pivot 18, said sleeve being mounted on a wing root rib 20, said rib comprising a part of a package of condensed telescopic wing surfaces, each attached to a rib or ribs 4, said package being mounted on a rib/skin-package support tray 17, said tray being attached to a rib/skin-package pivot 16 located at the forward end of said support tray 17, allowing said tray 17 together with said package 4 to rotate around said pivot 16 such that the rear end of said package 4 and tray 17 can rotate outward and forward away from a stowed position substantially parallel with a fuselage 19, to a an interim position as shown in FIG. 7B perpendicular to said spar 1 or spars 1,2, said interim position being achieved by moving said spar 1 from its stowed position in FIG. 7A toward said package 4, thus causing the end of said spar 1 which is inserted in said root rib sleeve pivot 18 to push against said rib/skin-package 4, causing said package 4 to rotate forward and outward on said tray 17 around said rib/skin-package pivot. At said interim position, said spar or spars 1,2 being at an angle (dependent on any wing sweep) substantially perpendicular to said package 4 and said spar or spars 1,2 being aligned with holes in each rib typical of holes in ribs in the current state of the art. As insertion of said spar or spars 1, 2 continues (FIGS. 7C-F), said spar or spars 1,2 rotate in the same direction as said package 4. Due to rotation around different pivots 14, 16, the position of said spar pivot 14 on said rail 15 must alter constantly. (Note: said spar 1 does not slide in or parallel to said rail 15. Only said pivot 14 runs in said rail 15 while said spar 1 is free to rotate.) Said rotation ends when said spar 1 reaches a position substantially perpendicular to said fuselage 19, thus assembling an aerodynamic wing 7. The root portion of said spar 1 is braced at a bulkhead 60 for flight. Non-restrictive embodiments of the foregoing in a roadable airplane can be viewed in FIGS. 16 and 17.

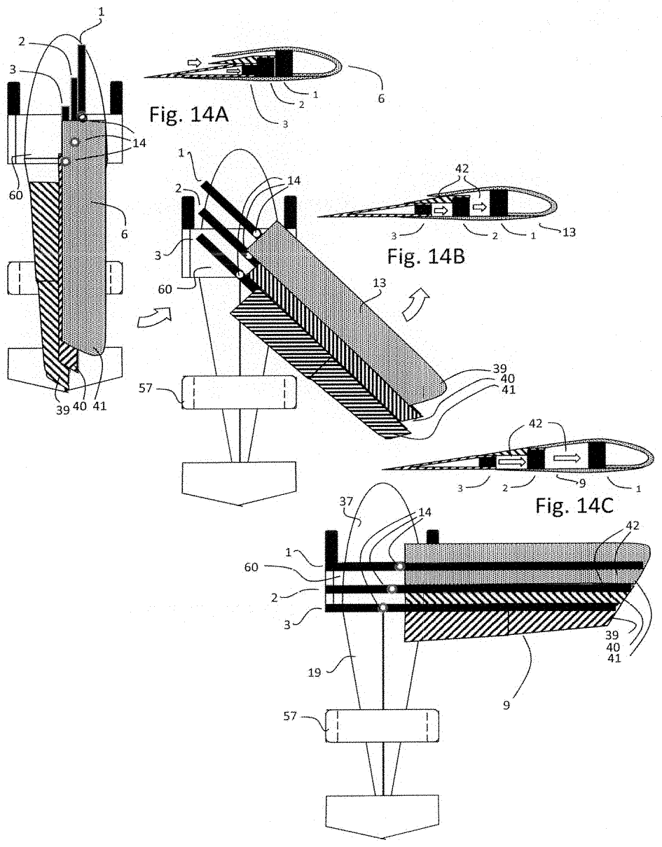

With reference to FIG. 8A, an unsegmented spar or spars stowed, mounted and rotated in a manner substantially similar to FIGS. 7A-F, has its forward tip in a sleeve pivot 18 attached to the root rib 20 of an accordion-like package of ribs/skin 5. Said package is substantially enclosed in a rigid root telescopic segment 61 which is mounted on a rib/skin-package support tray 17. The outward and forward rotation of said tray 17, said rigid telescopic segment 61 and said package 5 is accomplished in a similar manner to achieve a similar position perpendicular to the spar 1 in line with the holes in the ribs as in FIG. 7B. This is shown in FIG. 8B. As rotation continues and said spar 1 continues pushing through said sleeve 18 against said root rib 20 of said package 5, said tray 17 extends, said package 5 moves outward through said rigid segment 61 and said package expands in an accordion-like manner. Rotation as described in FIGS. 7B-E and shown in FIGS. 8B-E continues until said spar reaches its deployed position substantially perpendicular to said fuselage 19 as shown in FIG. 8F and an aerodynamic wing 8 has been assembled, whereupon the roots of said spar are secured to a bulkhead 60.

Said support tray 17 shown in FIGS. 6, 8 and 17 is an additional option for the purpose of regulating the distance from the fuselage at which a wing's root is deployed for flight and for lessening the speed of the final stage of spar rotation. The invention can be embodied with or without said support tray 17. Embodiments of the invention are not restricted by the presence or absence of a support tray 17.

A rigid root telescopic segment 61 is shown in FIG. 8 to illustrate how one or many such rigid telescopic segments 61 can be combined with an accordion-like rib/skin-wing package 5. The embodiment described here is non-restrictive regarding an exclusive or a combined application of telescopic or accordion-like rib/skin packages.

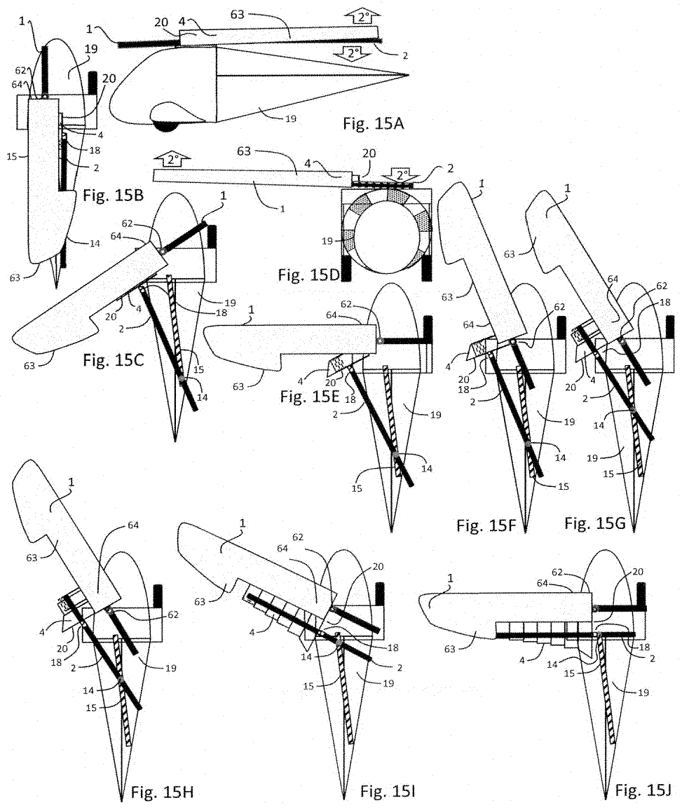

Said spars 1 and rails 15 can be mounted at differing heights as shown in FIGS. 6, 7, 8, 17, 18 and 19, or mounted at the same height but angled toward each other around the longitudinal axis of a fuselage as shown in FIGS. 9 and 16, and supported by rotating outer bulkhead joints 61 such that the root ends of said spars 1 are free to rotate past each other until a deployed position substantially perpendicular to a fuselage is reached, whereupon said spars 1 can be levelled In this regard, the embodiments described and shown here are non-restrictive.

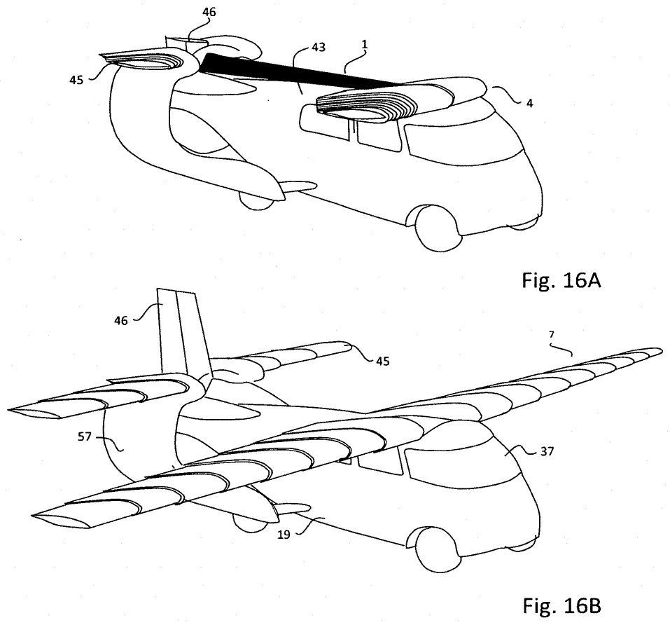

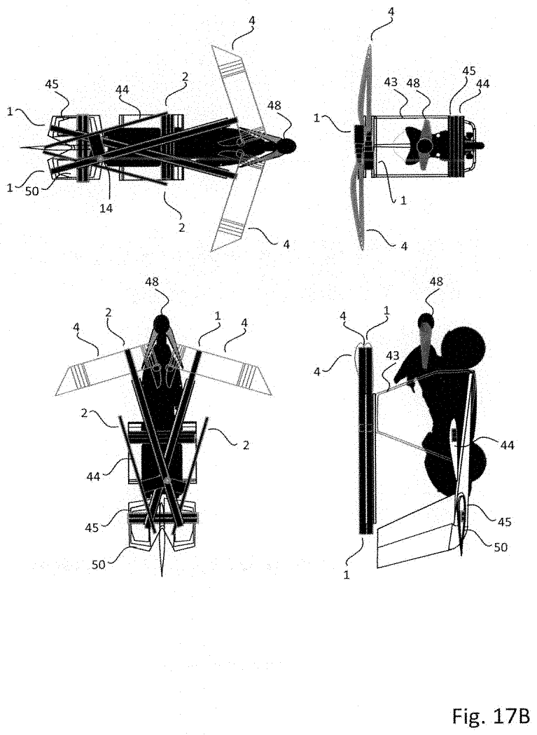

Referring to FIG. 12, an unsegmented wing spar 1 (or spars) is constructed such that its height and width reduce stepwise at each rib from the wing root rib 20 toward the outermost telescopic wing segment 25, or in the case of an accordion-like wing toward the wingtip, and that each spar cross-section at each point where it passes each rib when deployed for flight is shaped such that it determines the angle of incidence of each rib in a manner known to persons versed in the art as wash-out whereby the angle of incidence at the root 23 is higher than at the tip 24, as shown in FIG. 10A.

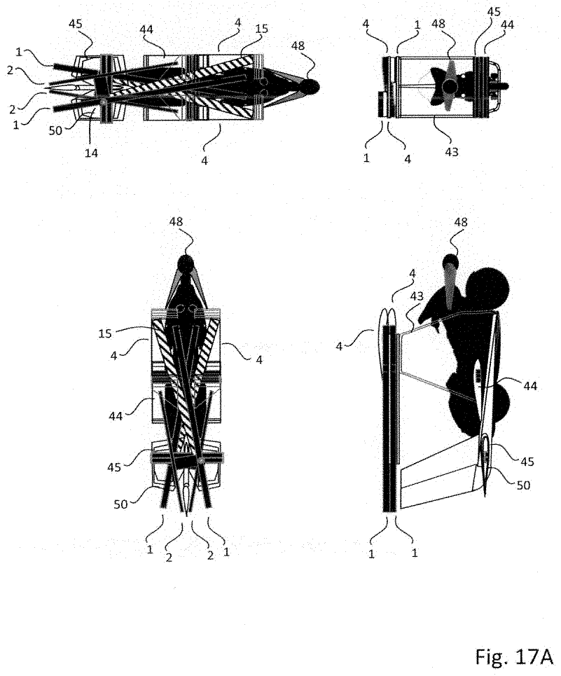

Referring to FIGS. 11 and 12, the angle of incidence of the outer wing segments 25, 26, 27 is alterable around the spar's 1 longitudinal axis upward 35 (see FIG. 11C) and downward 34 (see FIG. 11B) to effect roll control in a manner known to those versed in the art as wing warping. Movement of the outermost wing segment 25 can be effected in many ways ranging from fly-by-wire to traditional mechanical means. FIGS. 11 and 12 show a mechanical arrangement whereby a rectangular sleeve 28 is attached to the outmost rib 30 and rotates around a circular central spar 29. In said mechanical arrangement shown, a linkage (lever, cog or other) proximal to the root of the wing 33 is moved via input from the pilot. Said linkage 33 engages and turns a steering rod linkage 32, causing a steering rod 36 and its linkage at the wingtip end 31 of said spar 1 to turn, thus engaging the turning unit at the outermost rib 30 to which the outermost wing segment 25 is attached. Turning said outermost segment 25 causes neighboring segments 26, 27 (or more, or less) to turn in a similar but lesser manner due to these being connected either via an expanded package of rigid telescopic elements or via an expanded package of accordion-like rib/skin.

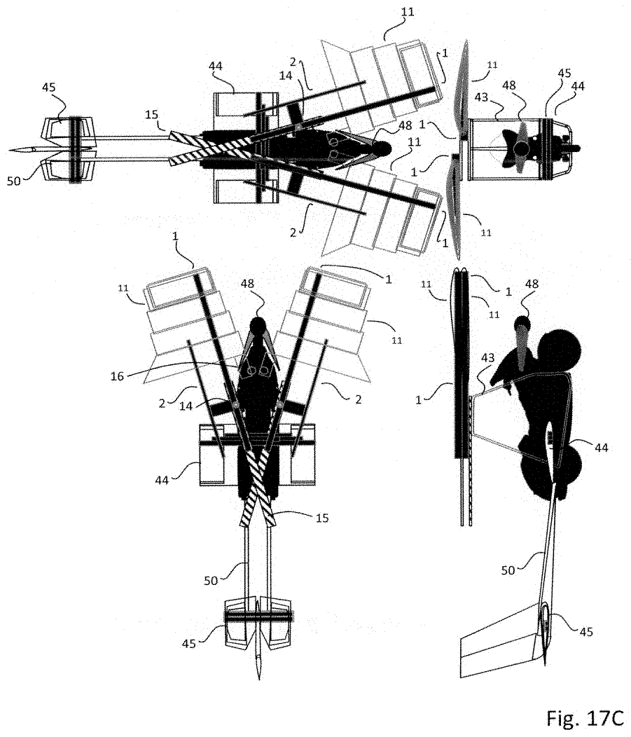

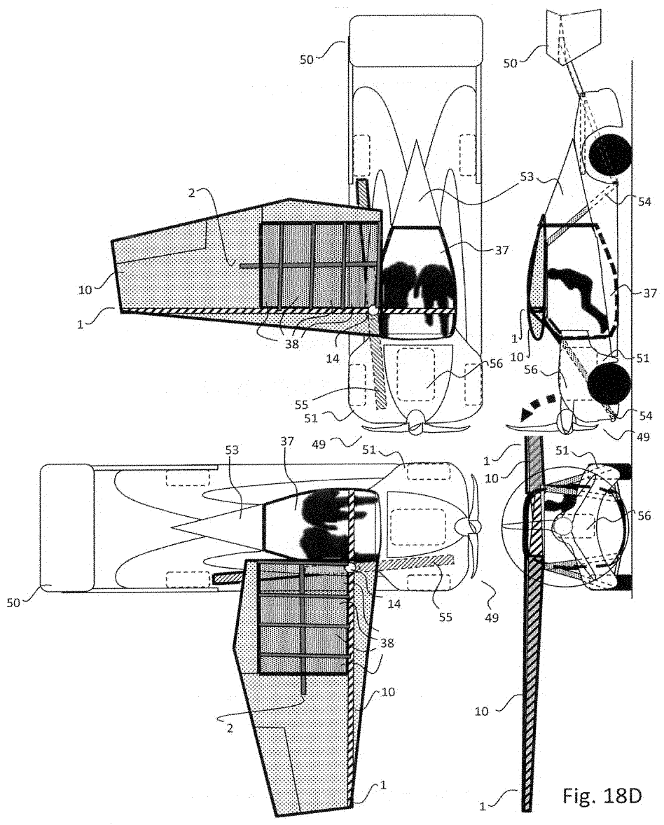

Referring to FIG. 13, a telescopic rib/skin-package 4 and an auxiliary spar 2 are enclosed within a outboard portion of a rotatable host wing 10, said host wing having a gap in its inboard portion surrounding a cabin 37 when in its stowed position substantially parallel and proximal to a fuselage 19 (see FIG. 13A). (In other embodiments, said gap could be in the outboard rather than the inboard wing portion or at or near mid-wing having two smaller rib/skin-packages and auxiliary spars on each side of it.) After the host wing 10 including its unsegmented spar 1 have been rotated via a pivot 14 from a position substantially parallel to said fuselage 19 to a position substantially perpendicular to said fuselage 19 (see FIGS. 13B-C), said auxiliary spar 2 expands said package 4 to fill said gap 38 in said host wing 10. A non-restrictive embodiment of the foregoing in a roadable airplane is shown in FIG. 18 wherein rotation of said host wing 10 past said cabin 37 is made possible by first forwardly tilting a cowling 51, 52, then hoisting said host wing 10 on wing-raising structural elements 54, said elements being supported by a rail 55.

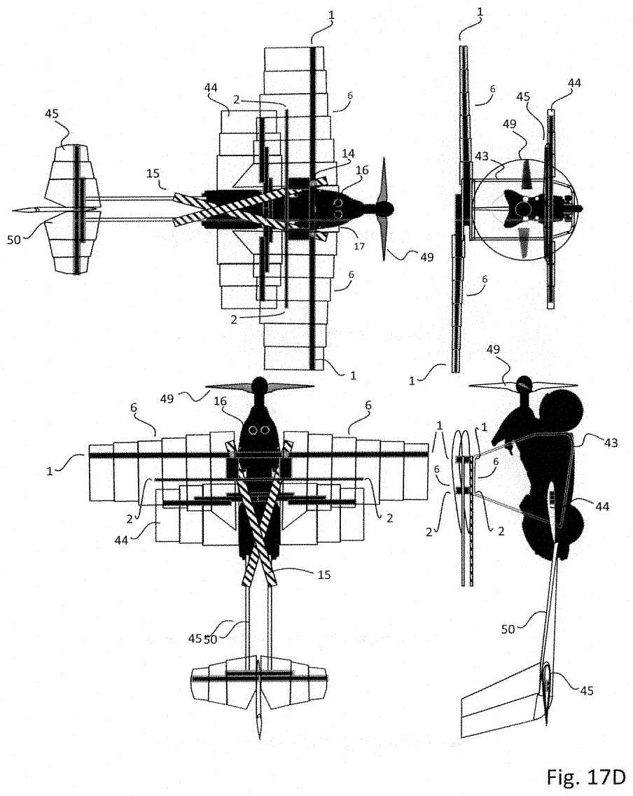

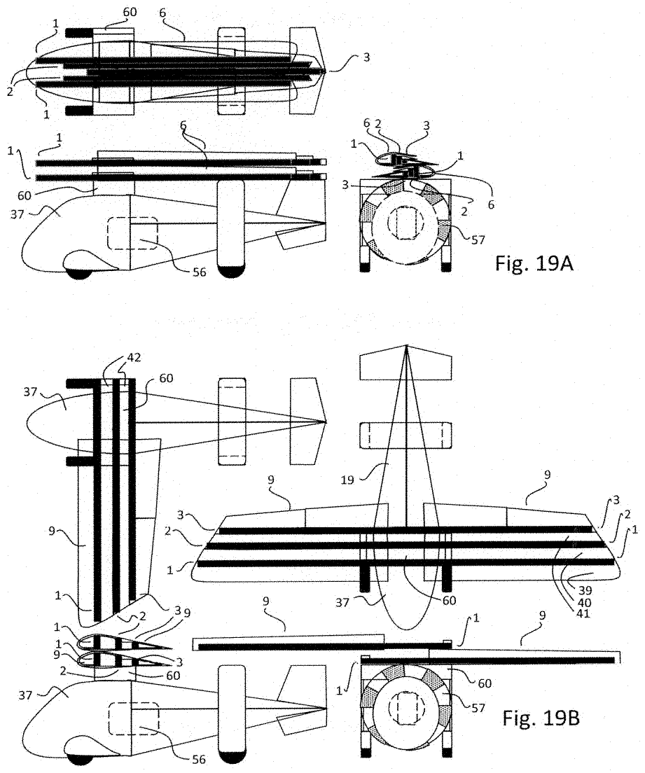

Referring to FIG. 14A, three unsegmented wing spars 1, 2, 3, each having an attached telescopic wing surface, respectively 39, 40, 41, are stowed substantially parallel and proximal to a fuselage 19 with little or no space between them. Each spar 1, 2, 3 is attached to and supported by a pivot 14 located on a bulkhead 60. Said pivots are placed apart at a distance which is the same as the distance said spars 1, 2, 3 will be apart once they have been rotated from substantially parallel to substantially perpendicular to said fuselage 19. During said rotation, the space 42 between said spars 1, 2, 3 increases (see FIG. 13B) and reaches its maximum at said deployed position substantially perpendicular to said fuselage 19 (see FIG. 14C). In said deployed position, said telescopic wing surfaces 39, 40, 41 attached to said spars 1, 2, 3 have expanded to form an aerodynamic wing 9. Said spars 1, 2, 3 and/or said attached surface elements 39, 40, 41 are loosely connected via metallic, organic or synthetic wires/ropes (not shown) in said stowed position. Said wires/ropes are pulled taut to prevent flatter in the deployed position. Alternately, mechanical latches which are unlatched in the stowed position and latched in the deployed position are employed. A non-restrictive embodiment of the foregoing in a roadable airplane is shown in FIG. 19.

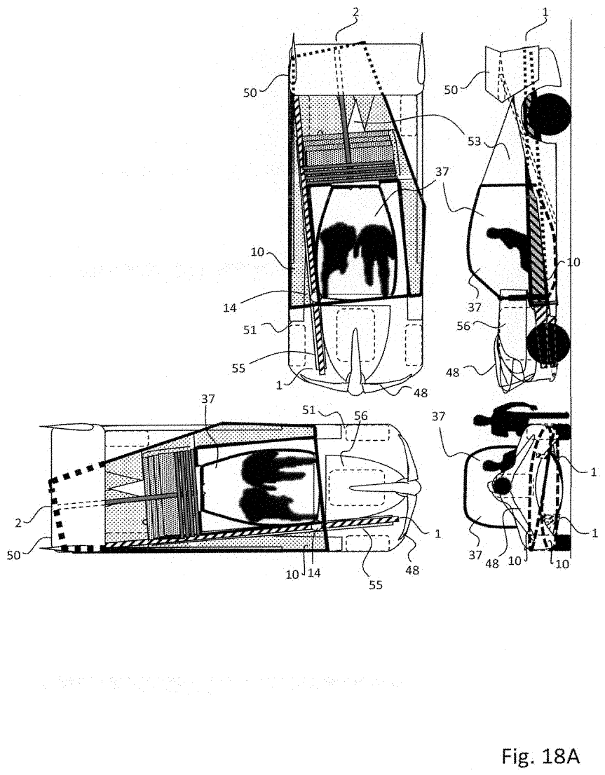

Referring to FIG. 15A, an unsegmented wing spar 1 having an attached telescopic wing surface with whole wingtip 63 is stowed substantially parallel and proximal to a fuselage 19. Said Spar 1 is attached to a pivot 62 located near one end of said spar 1. The other end of said spar 1 is angled slightly upward at approximately two degrees (see FIG. 15B), this being a typical angle for what is known to those versed in the art as dihedral. When said spar is rotated around said pivot 62 to a deployed position substantially perpendicular to said fuselage, said spar 1 and its attached telescopic surface with whole wingtip 63 have dihedral for the purpose of enhancing lateral roll stability around said fuselage's 19 longitudinal axis. An unsegmented auxiliary spar 2 (and any further spars) is stowed substantially parallel and proximal to said fuselage 19. Said Spar 2 is attached to a pivot 14 located near one end of said mainspar 1. Said pivot 14 is movable along a rail 15. In said spar's 1 stowed position, said pivot is at or near one end of said rail 15. Said auxiliary spar 2 and said rail 15 are angled upward at approximately two degrees at the end of said spar 2 and said rail 15 opposite to said pivot 14 for the purpose of dihedral when said spar 2 is rotated and deployed for flight substantially perpendicular to said fuselage 19. Said spars 1,2 are stowed substantially parallel to one another and substantially beside one another. In their respective stowed positions, the angle of said spars 1, 2 for purposes of dihedral is diametrical, meaning the end of spar 1 is low beside the end of the other spar 2 which is high and vice versa. Said whole wingtip integral to said telescopic surface 63 and spar 1 is stowed above said auxiliary spar 2 in the space created by the dihedral angle (see FIG. 15B). A package of condensed telescopic wing ribs/surfaces 4 or a package of condensed accordion-like wing ribs/skin 5, is attached to a pivot 64 which is attached to said spar 1. The root rib 20 of said package 4/5 is attached to a root sleeve pivot 18. Said package therefore is attached to two pivots: 18 and 64. When said auxiliary spar 2 is moved toward the other end of said rail 15, it pushes against said package 4/5, causing said main spar 1 to rotate outward away from said fuselage 19 (see FIG. 15C). When said package 4/5 and its root rib 20 reach an angle substantially perpendicular to said auxiliary spar 2, said auxiliary spar is aligned with holes in the ribs of said package 4/5 and is inserted therein, whereupon rotation of said package 4/5 slows while rotation of said main spar 1 and attached surfaces and wingtip 63 continues (see FIGS. 15E-G). Once said auxiliary spar 2 is inserted into said package 4/5, slow rotation of both spars 1, 2 in the opposite direction commences and continues until said spars 1,2 are substantially perpendicular to said fuselage 19 (see FIGS. 15H-I), said package 4/5 is fully expanded and an aerodynamic wing has been formed (see FIG. 15J). Means for binding said expanded package 4/5 with inserted auxiliary spar 2 to said main spar 1 and/or attached surfaces and wingtip 63 such as or similar to wires and latches (not shown) can be provided [FIG. 15 shows a non-restrictive embodiment of principles of flight physics in the invention whereby an integral nose structure along the wing's leading edge serves to withstand the greatest direct and torsional forces encountered by a wing in flight, thereby shielding the telescopic structure. Nevertheless, a wing thus assembled will likely remain weaker than a state-of-the-art integral wing, despite the invention's improvement of the state of the art for telescopic wings by embodiment of an unsegmented spar.]

Nothing in these detailed descriptions of preferred embodiments should be construed as limiting the scope of the application of the various parts of the invention in other embodiments, ways or contexts.

### REFERENCE KEY

| | |
|---|---|
| 1 | Main unsegmented spar |
| 2 | Auxiliary/Secondary unsegmented spar |
| 3 | Tertiary unsegmented spar |
| 4 | Package of condensed telescopic wing surfaces, each attached to a rib or ribs |
| 5 | Package of condensed accordion-like wing skin intervally attached to ribs |
| 6 | Package of condensed telescopic wing surfaces, each attached to an unsegmented spar |
| 7 | Aerodynamic wing assembled from expanded package of telescopic surfaces surfaces, each |
| | attached to a rib or ribs, and a to rotatable unsegmented spar |
| 8 | Aerodynamic wing assembled from expanded package of accordion-like wing skin intervally |
| | attached to ribs, and to a rotatable unsegmented spar |
| 9 | Aerodynamic wing assembled from expanded package of telescopic surfaces surfaces, each |
| | attached to a rotatable unsegmented spar |
| 10 | Host wing having a telescopically fillable gap from its main spar to its trailing edge stringer, |
| | and from its root rib to its approximate mid-point, and having a rotatable spar or spars |
| 11 | Partially extended package of telescopic wing surfaces, each attached to a rib or ribs |
| 12 | Partially extended package of accordion-like wing skin intervally attached to ribs |
| 13 | Partially extended package of telescopic wing surfaces, each attached to a spar |
| 14 | Spar rail pivot |
| 15 | Spar pivot supporting rail |
| 16 | Rib/skin-package pivot |
| 17 | Rib/skin-package support tray |
| 18 | Root rib spar sleeve pivot |
| 19 | Fuselage |
| 20 | Root rib |
| 21 | Elongated rib cavity |
| 22 | Rib-cavity-bridging-trolley-with-spar-sleeve |
| 23 | Line showing angle of incidence of wing underside at its root |
| 24 | Line showing angle of incidence of wing underside at its tip |
| 25 | Outermost telescopic wing element |
| 26 | Second-outermost telescopic wing element |
| 27 | Third-outermost telescopic wing element |
| 28 | Rectangular sleeve around outermost spar steps |
| 29 | Circular spar core at outermost spar steps |
| 30 | Turning unit at outermost rib engaged by steering rod linkage |
| 31 | Steering rod linkage at wingtip |
| 32 | Steering rod linkage at wing root |
| 33 | Linkage engaging steering rod linkage at wing root |
| 34 | Line showing downward angle of outermost telescopic wing element when turned |
| 35 | Line showing upward angle of outermost telescopic wing element when turned |
| 36 | Steering rod |
| 37 | Cabin |
| 38 | Telescopic wing elements extended across gap in a wing subsequent to rotation |
| 39 | Telescopic wing surface attached to front spar |
| 40 | Telescopic wing surface attached to median spar |
| 41 | Telescopic wing surface attached to rear spar |
| 42 | Space between spars |
| 43 | Substructure supporting pivot rail |
| 44 | Simple telescopic wing having non-rotating spar |
| 45 | Simple telescopic horizontal stabilizer having non-rotating spar |
| 46 | Simple telescopic vertical stabilizer having non-rotating spar |
| 47 | Extending empennage |
| 48 | Folded propeller & spinner |
| 49 | Propeller & spinner |
| 50 | Extending twin-boom empennage |
| 51 | Cowling/hood/bonnet |
| 52 | Forwardly tilted cowling/hood/bonnet |
| 53 | Retracting teardrop -shaped slipstream fairing |
| 54 | Wing-raising structural elements |
| 55 | Rail for wing-raising structural elements |
| 56 | Motor |
| 57 | Ducted Fan |
| 58 | Twin vertical stabilizers |
| 59 | Wingtip rib spar pivot |
| 60 | Bulkhead |
| 61 | Rigid root telescopic segment |
| 62 | Spar pivot |
| 63 | Telescopic wing surface with whole wingtip attached to an unsegmented spar |
| 64 | Spar-mounted rib/skin-package pivot |

1. Automatable assembly and deployment of an aerodynamic wing from components stowed proximal to a fuselage, reversible for stowage, characterized by combination of an unsegmented spar or spars stowed substantially parallel to said fuselage, with condensed telescopic wing surfaces or condensed accordion-like wing skin or a combination of said surfaces and skin, such that said spar or spars rotate to deploy substantially perpendicular to said fuselage.

2. Automatable assembly and deployment of an aerodynamic wing as in claim 1, characterized by a condensed package of ribs and telescopic wing surfaces or accordion-like package of ribs and wing skin or a combined package of ribs with said surface and said skin, being affixed parallel and proximal to a flank of said fuselage such that said package can only expand in a spanwise trajectory away from said fuselage, an unsegmented spar or spars being inserted into said package through elongated cavities in said ribs and expanding said package spanwise, said spar or spars rotating from a stowed position substantially parallel to said fuselage to a deployed position substantially perpendicular to said fuselage to form an aerodynamic wing in combination with said expanded package.

3. Automatable assembly and deployment of an aerodynamic wing as in claim 2, characterized by a trolley moveable along said elongated cavity in said ribs, said trolley having a sleeve into and through which said spar or spars insert and traverse.

4. Automatable assembly and deployment of an aerodynamic wing as in claim 1, characterized by a condensed package of ribs and telescopic wing surfaces or accordion-like package of ribs and wing skin or a combined package of ribs with said surface and said skin, being mounted on a pivot mounted proximal to a flank of said fuselage, said pivot being attached to the root rib of said package, each of said ribs in said package having a hole or holes through which a spar or spars can pass, the root rib having a sleeve pivot at each hole or holes to which a tip or tips of a spar or spars can be attached and through which said spar or spars can pass, said spar or spars being stowed substantially parallel to said fuselage, said spar or spars rotating to a deployed position for flight substantially perpendicular to said fuselage, said root rib of said package rotating away from said fuselage until a point is reached at which said spar or spars are aligned with said holes or holes in said ribs of said package, said spar or spars at said point commencing insertion into said hole or holes, said package and said spar or spars from this point onwards rotating in the same direction as each other, said package expanding as said spar or spars insert further and rotation continuing until said spar or spars are fully inserted into and has/have fully expanded said package and is/are substantially perpendicular to said fuselage.

5. Automatable assembly and deployment of an aerodynamic wing as in claim 4, characterized by a tray, not said root rib, being attached to said fuselage and said package being mounted on said tray such that said package at of after said point at which said spar or spars are aligned with said holes in said ribs, moves across said tray away from the root end of said spar.

6. Automatable assembly and deployment of an aerodynamic wing as in claims 2, 3, 4, and 5 with means to equip said wing with wash-out for improved stall safety, characterized by steps of successively reducing cross-section of said spar or spars from its/their root/s to its/their tip/s and accompanying reduction of the size of said holes in said ribs through which said spar or spars pass(es), the inner said steps and said ribs near said root end of said spar/s and said package having a shape dictating deployment of said ribs around said spar/s at a higher angle of incidence, and the outer said steps and said ribs near said wingtip end of said spar/s and said package having a shape dictating deployment of said ribs around said spar/s at a lower angle of incidence, such angle determining the angle of accompanying said wing surfaces or said wing skin attached to said ribs.

7. Automatable assembly and deployment of an aerodynamic wing as in claims 2, 3, 4, 5 and 6, having only one unsegmented spar with means to equip said wing with wing warping for lateral steering, characterized by an outer portion of said spar over a length which encompasses one or more of said ribs in their deployed positions, having a circular cross section around which at least one angular sleeve or one angular sleeve per rib is mounted, said sleeve or sleeves rotating around said circular core, thus imparting to the ribs and accompanying surfaces or skin an upward or downward angle of incidence.

8. Automatable assembly and deployment of an aerodynamic wing as in claim 7, characterized by said holes in said ribs having a shape and size allowing said spar and a steering rod to be inserted through them, said steering rod being attachable to a cockpit linkage and/or being rotatable by input from said cockpit or remote pilot, said rotation of said rod actuating a wheel, lever or other linkage, thus causing said angle of incidence of said outer wing portion comprising at least the outermost wingtip rib of said expanded package and said surface or skin attached thereto, to alter.

9. Automatable assembly and deployment of an aerodynamic wing as in claim 1, characterized by a host wing being stowed substantially parallel and proximal to a fuselage and being rotatable to deploy substantially perpendicular to said host wing, said host wing having a rotating spar or spars and a hole located in a portion of its wing between its root rib and its wingtip, said host wing having a condensed package or packages of ribs and rigid telescopic wing surfaces and or accordion-like wing skin mounted within its skin or surface structure adjacent to said hole, said package or packages having an auxiliary spar or spars mounted partially within said package or packages, said auxiliary spar or spars movable into said package or packages, thus expanding them across said hole.

10. Automatable assembly and deployment of an aerodynamic wing as in claim 1, characterized by rotatable main and auxiliary spars stowed substantially parallel and proximal to a fuselage with little or no space between said stowed spars, said spars' rotation pivots being placed apart at such a distance that when they are rotated to deploy substantially perpendicular to said fuselage for flight they line up as main and auxiliary spars with an amount of space between them as required by flight physics, said spars each having attached rigid telescopic wing surface segments which are condensed in said spars' stowed position, and fully expanded to form an aerodynamic wing in said spars' deployed position.

11. Automatable assembly and deployment of an aerodynamic wing from components stowed proximal to a fuselage, reversible for stowage, as in claim 10, characterized by highly elastic wing skin and/or wing skin equipped with slack roll-up capability attached to and between neighboring spars (rather than rigid telescopic wing segments attached only to each spar).

12. Automatable assembly and deployment of an aerodynamic wing from components stowed proximal to a fuselage, reversible for stowage, as in claim 1, characterized by a telescopic wing surface and whole wingtip portion attached to a rotatable main spar stowed parallel and proximal to said fuselage, said spar and said attachments mounted at a slight dihedral angle, said spar and said attachments attached via a pivot to a condensed package of ribs and rigid telescopic wing surfaces or accordion-like wing skin, said package attached via a sleeve pivot to one end of an auxiliary spar or spars, said auxiliary spar/s attached at its other end via a pivot to a trolley running along a rail on or near a fuselage, said auxiliary spar/s being stowed substantially proximal and parallel to a fuselage at a slight dihedral angle, such that said wingtip portion is stowable above or below said auxiliary wing/s, said auxiliary spar/s being movable along said rail, said auxiliary spar/s′ movement causing its end attached via pivot to said package and said main wing to move away from said fuselage, said main wing rotating around its attached pivot located at or near said fuselage, and said auxiliary spar/s rotating around said rail-mounted pivot until a point is reached at which said auxiliary spar is aligned with holes in said ribs of said package, said auxiliary spar inserting into said package, thereby expanding it, said main spar continuing to rotate until parallel with said auxiliary spar/s, said auxiliary spar/s fully inserting into and expanding said package, said main and auxiliary spars and said expanded package deploying substantially perpendicular to said fuselage.
